(19) United States
(12) Patent Application Publication
(10) Pub. No.: US 2007/0238834 A1
(43) Pub. Date: Oct. 11, 2007

(54) Polypropylene composition

(75) Inventors: Hideaki Hori, Sodegaura-shi (JP); Takeshi Ebara, Chiba-shi (JP); Yoichi Obata, Sodegaura-shi (JP)

Correspondence Address: BIRCH STEWART KOLASCH & BIRCH, PO BOX 747, FALLS CHURCH, VA, 22040-0747, US

(73) Assignee: Sumitomo Chemical Company, Limited, Tokyo (JP)

(21) Appl. No.: 11/724,198

(22) Filed: Mar. 15, 2007

(30) Foreign Application Priority Data
Mar. 16, 2006 (JP) P2006-072572

(51) Int. Cl. C08F 8/00

(52) U.S. Cl. 525/191; 525/240

(57) ABSTRACT

A polypropylene composition including 0.1 to 15% by weight of (A1) a propylene homopolymer and 85 to 99.9% by weight of (B1) a copolymer of propylene and an α-olefin having at least 4 carbon atoms in which component (B1) contains 0.1 to 5% by weight of α-olefin, or a polypropylene composition comprising 0.1 to 15% by weight of (A2) a copolymer of propylene and an α-olefin having at least 4 carbon atoms and 85 to 99.9% by weight of (B2) a copolymer of propylene and an α-olefin having at least 4 carbon atoms in which component (A2) contains 0.1 to 5% by weight of the α-olefin, component (B2) contains 0.2 to 5% by weight of α-olefin, and the content of the α-olefin in component (B2) is larger than the content of the α-olefin in component (A2).

### FIELD OF THE INVENTION

The present invention relates to polypropylene compositions. In particular, the present invention relates to polypropylene compositions excellent in dimensional stability at high temperatures and rigidity.

### BACKGROUND ART

Polypropylene films are used as package materials for foods and the like since they are excellent in optical characteristics and mechanical characteristics. For example, WO 96/11216 discloses a composition comprising a propylene-α-olefin copolymer having a high molecular weight, a wide molecular weight distribution and improved distribution of comonomers. This composition is prepared by a method comprising step (A) for producing a high molecular weight copolymer of propylene and an α-olefin comonomer and subsequent step (B) for producing a low molecular weight copolymer comprising adding propylene and an α-olefin comonomer to the copolymer prepared in step (A), and it is a mixture of copolymers with a ratio of the high molecular weight copolymer (A) to the low molecular weight copolymer (B) in a range of 40:60 to 70:30.

JP-A-2002-275328 discloses a polypropylene resin composition which shows less unevenness in its stretched condition in the production of a biaxially stretched film, which composition comprises 20 to 60% by weight of a propylene homopolymer and 40 to 80% by weight of a propylene-α-olefin random copolymer.

However, when the compositions disclosed by the above patent publications are processed to form a film such as a stretched film, further improvement in the dimensional stability at high temperatures and rigidity of the film is desired.

### SUMMARY OF THE INVENTION

An object of the present invention is to provide a polypropylene copolymer having excellent dimensional stability at high temperatures and rigidity.

According to one aspect, the present invention provides a polypropylene composition comprising 0.1 to 15% by weight of component (A1) that is a propylene homopolymer, and 85 to 99.9% by weight of component (B1) that is a copolymer of propylene and at least one α-olefin having at least 4 carbon atoms, provided that the total weight of component (A1) and component (B1) is 100% by weight, wherein component (B1) contains 0.1 to 5% by weight of α-olefin having at least 4 carbon atoms. Hereinafter, this polypropylene composition is sometimes referred to as the first composition.

According to another aspect, the present invention provides a polypropylene composition comprising 0.1 to 15% by weight of component (A2) that is a copolymer of propylene and at least one α-olefin having at least 4 carbon atoms and 85 to 99.9% by weight of component (B2) that is a copolymer of propylene and at least one α-olefin having at least 4 carbon atoms, provided that the total weight of component (A2) and component (B2) is 100% by weight, wherein component (A2) contains 0.1 to 5% by weight of α-olefin having at least 4 carbon atoms, component (B2) contains 0.2 to 5% by weight of α-olefin having at least 4 carbon atoms, and the content of the α-olefin having at least 4 carbon atoms in component (B2) is larger than the content of the α-olefin having at least 4 carbon atoms in component (A2). Hereinafter, this polypropylene composition is sometimes referred to as the second composition.

According to a further aspect, the present invention provides a film comprising the first composition or the second composition.

According to the present invention, a polypropylene composition excellent in dimensional stability at high temperatures and rigidity is obtained.

### DETAILED DISCLOSURE OF THE INVENTION

The first composition of the present invention comprises 0.1 to 15% by weight of component (A1) that is a propylene homopolymer, and 85 to 99.9% by weight of component (B1) that is a copolymer of propylene and at least one α-olefin having at least 4 carbon atoms, provided that the total weight of component (A1) and component (B1) is 100% by weight, in which component (B1) contains 0.1 to 5% by weight of α-olefin having at least 4 carbon atoms.

The content of component (A1) is 0.1 to 15% by weight, preferably 1 to 15% by weight, more preferably 1 to 10% by weight, that is, the content of component (B1) is 85 to 99.9% by weight, preferably 85 to 99% by weight, more preferably 90 to 99% by weight. When the content of component (A1) is less than 0.1% by weight, that is, when the content of component (B1) exceeds 99.9% by weight, the heat shrinkage factor of the film may be too large or the rigidity (Young's modulus) of the film may be too low. When the content of component (A1) exceeds 15% by weight, that is, the content of component (B1) is less than 85% by weight, the stretchability of the film may deteriorate.

When the first composition of the present invention is prepared by a multi-stage polymerization method, the ratio of the content of component (A1) to that of component (B1) may be adjusted by controlling a polymerized amount in the step for producing component (A1) and a polymerized amount in the step for producing component (B1).

The content of the α-olefin having at least 4 carbon atoms in component (B1) is 0.1 to 5% by weight, preferably 0.1 to 4% by weight. When the content of the α-olefin is less than 1% by weight, the stretchability of the film may deteriorate. When the content of the α-olefin exceeds 5% by weight, the heat shrinkage factor of the film may be too large or the rigidity (Young's modulus) of the film may be too low.

The content of the α-olefin having at least 4 carbon atoms in component (B1) may be adjusted by controlling the ratio of the amount of the propylene monomer to the amount of the α-olefin having at least 4 carbon atoms to be polymerized in the preparation step of component (B1).

The second composition of the present invention comprises 0.1 to 15% by weight of component (A2) that is a copolymer of propylene and at least one α-olefin having at least 4 carbon atoms and 85 to 99.9% by weight of component (B2) that is a copolymer of propylene and at least one α-olefin having at least 4 carbon atoms, provided that the total weight of component (A2) and component (B2) is 100% by weight, wherein component (A2) contains 0.1 to 5% by weight of α-olefin having at least 4 carbon atoms, component (B2) contains 0.2 to 5% by weight of α-olefin having at least 4 carbon atoms, and the content of the α-olefin having at least 4 carbon atoms in component (B2) is larger than the content of the α-olefin having at least 4 carbon atoms in component (A2).

The content of component (A2) is usually 0.1 to 15% by weight, preferably 1 to 15% by weight, more preferably 1 to 10% by weight, that is, the content of component (B2) is 85 to 99.9% by weight, preferably 85 to 99% by weight and more preferably 90 to 99% by weight. When the content of component (A2) is less than 0.1% by weight, that is, the content of component (B2) exceeds 99.9% by weight, the heat shrinkage factor of the film may be too large or the rigidity (Young's modulus) of the film may be too low. When the content of component (A2) exceeds 15% by weight, that is, the content of component (B2) is less than 85% by weight, the stretchability of the film may deteriorate.

When the second composition of the present invention is prepared by a multi-stage polymerization method, the ratio of the content of component (A2) to that of component (B2) may be adjusted by controlling a polymerized amount in the step for producing component (A2) and a polymerized amount in the step for producing component (B2).

The content of the α-olefin having at least 4 carbon atoms in component (A2) is 0.1 to 5% by weight, preferably 0.1 to 4% by weight, more preferably 0.1 to 3% by weight. When the content of the α-olefin exceeds 5% by weight, the heat shrinkage factor of the film may be too large or the rigidity (Young's modulus) of the film may be too low.

The content of the α-olefin having at least 4 carbon atoms in component (A2) may be adjusted by controlling the ratio of the amount of the propylene monomer to the amount of the α-olefin having at least 4 carbon atoms to be polymerized in the preparation step of component (A2).

The content of the α-olefin having at least 4 carbon atoms in component (B2) is 0.2 to 5% by weight, preferably 0.2 to 4% by weight. When the content of the α-olefin exceeds 5% by weight, the heat shrinkage factor of the film may be too large or the rigidity (Young's modulus) of the film may be too low.

The content of the α-olefin having at least 4 carbon atoms in component (B2) may be adjusted by controlling the ratio of the amount of the propylene monomer to the amount of the α-olefin having at least 4 carbon atoms to be polymerized in the preparation step of component (B2).

The α-olefin having at least 4 carbon atoms used in component (A2), (B1) or (B2) is preferably an α-olefin having 4 to 20 carbon atoms, more preferably 4 to 12 carbon atoms. Examples of such α-olefin include 1-butene, 2-methyl-1-propene, 1-pentene, 2-methyl-1-butene, 3-methyl-1-butene, 1-hexene, 2-ethyl-1-butene, 2,3-dimethyl-1-butene, 2-methyl-1-pentene, 3-methyl-1-pentene, 4-methyl-1-pentene, 3,3-dimethyl-1-butene, 1-heptene, 2-methyl-1-hexene, 2,3-dimethyl-1-pentene, 2-ethyl-1-pentene, 2,3,4-trimethyl-1-butene, 2-methyl-3-ethyl-1-butene, 1-octene, 5-methyl-1-pentene, 2-ethyl-1-hexene, 3,3-dimethyl-1-hexene, 2-propyl-1-heptene, 2-methyl-3-ethyl-1-heptene, 2,3,4-trimethyl-1-pentene, 2-propyl-1-pentene, 2,3-diethyl-1-butene, 1-nonene, 1-decene, 1-undecene, 1-dodecene, etc. Among them, 1-butene, 1-pentene, 1-hexene and 1-octene are preferable, and in particular, 1-butene and 1-hexene are preferable from the viewpoint of copolymerizabilities and production costs.

The content of components soluble in xylene at 20° C. (CXS) in the first and second compositions of the present invention is preferably 3% by weight or less, more preferably 2% by weight or less, particularly preferably 1% by weight or less, from the viewpoint of the heat shrinkage factor and the rigidity (Young's modulus) of the film produced from those compositions.

The melt flow rate (MFR) of the first and second compositions of the present invention is preferably 0.1 to 20 g/10 min., more preferably 0.1 to 10 g/10 min., particularly preferably 1 to 5 g/10 min. from the viewpoint of fluidity of the compositions in extrusion processing and the prevention of breakage of the film during stretching.

The melting point of the first and second compositions is preferably 155 to 166° C., more preferably 156 to 164° C., particularly preferably 156 to 163° C., from the viewpoint of the balance of the stretchability and the heat shrinkage factor and rigidity of the film.

The first and second compositions of the present invention may be produced by conventional polymerization methods using known polymerization catalysts.

Examples of the known polymerization catalyst include:

(1) a Ti—Mg catalyst comprising a solid catalyst component containing magnesium, titanium and halogen as essential elements;

(2) a catalyst system comprising a combination of a solid catalyst containing magnesium, titanium and halogen as essential elements with an organic aluminum compound and optionally a third component such as an electron donating compound; and

(3) a metallocene catalyst.

Among them, the catalyst system comprising a combination of a solid catalyst containing magnesium, titanium and halogen as essential elements with an organic aluminum compound and an electron donating compound is preferable.

Examples of the solid catalyst component comprising magnesium, titanium and halogen as essential elements are catalyst systems described in JP-A-61-218606, JP-A-61-287904 and JP-A-7-216017.

Examples of the organic aluminum compound include triethylaluminum, triisobutylaluminum, a mixture of triethylaluminum and diethylaluminum chloride, tetraethyldialumoxane, etc.

Examples of the electron donating compound include tert-butyl-n-propyldimethoxysilane, tert-butylethyldimethoxysilane, dicyclopentyldimethoxysilane, cyclohexylethyldimethoxysilane, etc.

The first composition of the present invention may be produced by a method comprising a first step for preparing component (A1) by polymerization of monomers and a second step for preparing component (B1) by polymerization of monomers. The second composition of the present invention may be produced by a method comprising a first step for preparing component (A2) by polymerization of monomers and a second step for preparing component (B2) by polymerization of monomers. For example, the first composition of the present invention may be produced by blending component (A1) and component (B1), which have been separately prepared. Alternatively, the first composition of the present invention may be produced by a multi-stage polymerization method comprising a first step for preparing component (A1) by polymerizing monomers, and a second step for preparing component (B1) by polymerizing monomers in the presence of component (A1) produced in the first step. Analogously, the second composition of the present invention may be produced by blending component (A2) and component (B2), which have been separately prepared, or by a multi-stage polymerization method comprising a first step for preparing component (A2) by polymerizing monomers, and a second step for preparing component (B2) by polymerizing monomers in the presence of component (A2) produced in the first step. Preferably, the first and second compositions are both produced by the multi-stage polymerization method.

The first step for preparing component (A1) or component (A2) may be carried out by solvent (solution) polymerization using an inert solvent, for example, a hydrocarbon (e.g. hexane, heptane, octane, decane, cyclohexane, methylcyclohexane, benzene, toluene and xylene) bulk (or mass) polymerization using a liquid monomer as a solvent; and gas phase polymerization performed in a gaseous monomer. Among them, the bulk polymerization or the gas phase polymerization is preferable from the viewpoint of the easiness of post-treatments of the polypropylene compositions produced.

The polymerization temperature in the first step for preparing component (A1) or component (A2) is usually 20 to 150° C., preferably 35 to 95° C., from the viewpoint of the productivity, the control of the contents of component (A1) and component (B1) or the contents of component (A2) and component (B2).

The second step for preparing component (B1) or component (B2) is usually carried out after performing the first step for preparing component (A1) or component (A2). The second step may be carried out in the same polymerization vessel as one used in the first step. Alternatively, the copolymer prepared in the first step is transferred from a polymerization vessel used in the first step (first polymerization vessel) to another polymerization vessel used in the second step (second polymerization vessel), and then the second step is carried out in the second polymerization vessel. The catalyst used in the first step may be deactivated or not prior to the polymerization in the second step.

Examples of the polymerization method in the second step for producing component (B1) or component (B2) include the same polymerization methods as those employed in the first step such as the solvent polymerization, the bulk polymerization and the gas phase polymerization. When the second step is carried out in a polymerization vessel different from that used in the first step, the polymerization methods in the first and second steps may be any combination selected from the solvent polymerization, the bulk polymerization and the gas phase polymerization.

Preferably, the first and second steps are both carried out by the bulk polymerization or the gas phase polymerization, or by the combination of the bulk polymerization and the gas polymerization from the viewpoint of the catalytic activity of the polymerization catalyst or the easiness of the post-treatments of the polypropylene compositions produced.

The polymerization temperature in the second step is usually 20 to 150° C., preferably 35 to 95° C.

After the production of the polypropylene composition of the present invention, the composition may be subjected to post-treatments such as deactivation of the catalyst, desolvation, removal of the monomers, drying and pelletization.

Additives or other resins may optionally be added to the polypropylene compositions of the present invention. Examples of the additives include antioxidants, UV absorbers, an antistatic agents, lubricants, nucleating agents, antifogging agents, antiblocking agents, etc. Examples of the other resins include polyolefin resins such as polyethylene resins, etc.

The first and second compositions of the present invention are useful as materials of films. The film produced from the first or second composition of the present invention has excellent dimensional stability at high temperatures and rigidity.

The film of the present invention may be a single layer film of the polypropylene composition or the blend thereof with other resin, or a multilayer film comprising a layer of the polypropylene composition or the blend thereof with other resin and a layer of another resin material. The thickness of the film of the present invention may not be limited, and the film of the present invention includes one having a thickness up to about 2 mm, and thus it encompasses a so-called “sheet”.

Examples of a method for producing the film of the present invention include an inflation method, a T-die method, a calendering method, etc. Examples of a method for producing the multilayer film include an extrusion lamination method, a heat lamination method, a dry lamination method, etc.

The film of the present invention encompasses a stretched film which may be produced by at least uniaxially stretching an unstretched film of the present invention. Examples of a stretching method include a uniaxial or biaxial stretching method by roll stretching, tenter stretching, tubular stretching, etc.

The film of the present invention is preferably an unstretched film, a multilayer film produced by the extrusion lamination method or a biaxially stretched film produced by the biaxial stretching method, from the viewpoint of the balance of properties such as transparency and rigidity.

The present invention will be illustrated in detail with reference to Examples and Comparative Examples. The methods for producing the samples used in the Examples and Comparative Examples and the methods for measuring the properties are explained below.

(1) Contents of Components (A1) and (B1), and Components (A2) and (B2), in Polypropylene Compositions (Unit: % by Weight):

These contents were calculated from mass balance in the production of the polypropylene compositions.

(2) 1-Butene Content (Unit: % by Weight)

A 1-butene content was determined by the IR spectral measurement described in “Polymer Analysis Handbook” (“KOBUNSI BUNSEKI HANDBOOK”), page 619 (1995; published by Kinokuniya Co., Ltd.).

A 1-butene content in component (B1) or component (B2) was calculated by the following equation using the content of component (A1) or component (A2) and the 1-butene content in component (A1) or component (A2):

{[1-butene content in polypropylene composition (wt. %)]×100-[1-butene content in component (A) (wt. %)×content of component (A) (wt. %)]}/[content of component (B) (wt. %)] wherein “component (A)” denotes component (A1) or component (A2), and “component (B)” denotes component (B1) or component (B2).

(3) Intrinsic Viscosity ([η], Unit: dl/g)

An intrinsic viscosity was measured in tetralin at 135° C. using an Ubbelohde viscometer. The intrinsic viscosities of components (A1), (A2), (B1) and (B2) are expressed by [η]_{A1}, [η]_{A2}, [η]_{B1} and [η]_{B2}, respectively.

The intrinsic viscosity [η]_{B1} of component (B1) or the intrinsic viscosity [η]_{B2} of component (B2) were calculated from the following equation using the intrinsic viscosity [η]_{A1} of component (A1) or [η]_{A2} of component (A2) measured after the completion of the polymerization in the first step, the intrinsic viscosity [η]_{AB} of the polypropylene composition measured after the completion of the polymerization in the second step, the weight fraction (P_{A1} (% by weight)) of component (A1) or the weight fraction (P_{A2} (% by weight)) of component (A2), and the weight fraction (P_{B1} (% by weight)) of component (B1) or the weight fraction (P_{B2} (% by weight)) of component (B2):
[η]_{B}=([η]_{AB}−[η]_{A}×P_{A}/100)×100/P_{B}
wherein [η]_{A} denotes [η]_{A1} or [η]_{A2}, [η]_{B} denotes [η]_{B1} or [η]_{B2}, P_{A} denotes P_{A1} or P_{A2}, and P_{B} denotes P_{B1} or P_{B2}.

(4) Content of Components Soluble in Xylene at 20° C. (CXS, Unit: % by Weight)

In 100 ml of boiling xylene, 1 g of a sample was dissolved completely. The resulting solution was cooled to 20° C., followed by allowing the solution to stand for 4 hours at that temperature to form precipitates. The solution was filtrated to remove the precipitates, and then the solvent was evaporated off from the filtrate, followed by drying at 70° C. under a reduced pressure to obtain a residue. The dried residue was weighed, and the ratio (% by weight) of the weight of the dried residue to the weight of the original sample (1 g) was calculated as a content of components soluble in xylene at 20° C. (CXS).

(5) Melt Flow Rate (MFR, Unit: g/10 min.)

MFR was measured at 230° C. under a load of 21.18 N according to JIS K7210.

(6) Melting Point (Tm, Unit: ° C.)

A polypropylene composition was heat-pressed by pre-heating it at 230° C. for 5 minutes, pressing it while increasing the pressure up to 50 kgf/cm² over 3 minutes and maintaining it at that pressure for 2 minutes, and then cooling it at 30° C. for 5 minutes under a load of 30 kgf/cm² to obtain a sheet having a thickness of 0.5 mm. A section (10 mg) of the sheet was conditioned with a differential scanning calorimeter (DSC-7 manufactured by PerkinElmer Inc.) by heating it at 220° C. for 5 minutes, cooling it down to 150° C. at a cooling rate of 300° C./min., maintaining it at 150° C. for 1 minute, further cooling it down to 50° C. at a cooling rate of 5° C./min. and maintaining it at 50° C. for 1 minute. Then, the conditioned sample was heated from 50° C. to 180° C. at a heating rate of 5° C./min. to record a melting curve. From the melting curve, a temperature (° C.) corresponding to the maximum endothermic peak was read and used as the melting point of the polypropylene composition.

(7) Heat Shrinkage Factor (Unit: %)

An A4 size film (210 mm×297 mm) was sampled so that the longitudinal direction of the film is in parallel with the machine direction (MD). Reference lines with a length of 20 cm were drawn on the film in the machine direction (MD) and transverse direction (TD), respectively, and the film was suspended in an oven maintained at a prescribed temperature (130° C. or 140° C.) for 15 minutes. Then, the film was taken out of the oven, and the lengths of the reference lines on the test film were measured after cooling at room temperature for 30 minutes. The shrinkage factor in each direction was calculated by the following equation:
Heat shrinkage factor (%)=[20−length (cm) of reference line after heating)/20]×100

The smaller heat shrinkage factor means better dimensional stability at high temperatures.

(8) Rigidity (Young's Modulus, Unit: MPa)

A test piece having a length of 120 mm and a width of 20 mm was cut out from a film so that the longitudinal direction of the test piece matches the machine direction (MD) of the film, and another test piece having a length of 120 mm and a width of 20 mm was cut out from the same film so that the longitudinal direction of the test piece matches the transverse direction (TD) of the film. With each test piece, an S—S curve was recorded using a tensile tester at a stretch rate of 5 mm/min. with a chuck distance of 60 mm. From the S—S curve, an initial elastic modulus (Young's modulus) of each test piece was measured and used as a measure of the rigidity of the film.

### EXAMPLE 1

### Synthesis of Solid Catalyst

After purging a SUS reaction vessel having an inner volume of 200 liters equipped with a stirrer with nitrogen, 80 liters of hexane, 6.55 moles of tetrabutoxytitanium, 2.8 moles of diisobutyl phthalate and 98.9 moles of tetrabutoxysilane were charged in the vessel while stirring to obtain a homogeneous solution. Then, 51 liters of a 2.1 mol/L solution of butylmagnesium chloride in diisobutyl ether was dropwise added slowly to the reaction vessel while maintaining the temperature of the reaction vessel at 5° C. Thereafter, the solution was stirred at room temperature for additional one hour and subjected to solid-liquid separation at room temperature. The recovered solid phase washed with 70 liters of toluene three times. Then, toluene was added to the solid and the mixture was kept standing.

After removing toluene until the solid content reached 0.6 kg/L, a mixture of 8.9 moles of di-n-butyl ether and 274 moles of titanium tetrachloride was added, and 20.8 moles of phthalyl chloride was further added and reacted at 110° C. for 3 hours. Thereafter, the reaction mixture was subjected to solid-liquid separation at the same temperature, and then the recovered solid phase washed with 90 liters of toluene twice at 95° C. Then, toluene was added to the solid and the mixture was kept standing.

The solid content was adjusted to 0.6 kg/L, and then 3.13 moles of diisobutyl phthalate, 8.9 moles of di-n-butyl ether and 137 moles of titanium tetrachloride were added and reacted at 105° C. for one hour. Thereafter, the reaction mixture was subjected to solid-liquid separation at the same temperature, and then the recovered solid phase washed with 90 liters of toluene twice at 95° C. Then, toluene was added to the solid and the mixture was kept standing.

Subsequently, the solid content was adjusted to 0.6 kg/L, and then 8.9 moles of di-n-butyl ether and 137 moles of titanium tetrachloride were added and then reacted at 95° C. for 1 hour. Thereafter, the reaction mixture was subjected to solid-liquid separation at the same temperature and the recovered solid phase washed with 90 liters of toluene three times at the same temperature. Then, toluene was added to the solid and the mixture was kept standing.

Furthermore, the solid content was adjusted to 0.6 kg/L, and then 8.9 moles of di-n-butyl ether and 137 moles of titanium tetrachloride were added and reacted at 95° C. for 1 hour.

After the completion of the reaction, the reaction product was subjected to solid-liquid separation at 95° C. and the recovered solid phase washed with 90 liters of toluene three times at the same temperature. After further washing the solid with 90 liters of hexane three times at room temperature, and the recovered solid phase was dried under a reduced pressure to obtain 11.0 kg of a solid catalyst.

The solid catalyst contained 1.89% by weight of titanium atoms, 20% by weight of magnesium atoms, 8.6% by weight of the phthalate ester, 0.05% by weight of the ethoxy group and 0.21% by weight of the butoxy group, and had good particle properties with no fine powders.

Preactivation of Solid Catalyst

To a SUS reaction vessel having an inner volume of 3 liters equipped with a stirrer, 1.5 liters of sufficiently dehydrated and degassed n-hexane, 37.5 mmoles of triethylaluminum, 3.75 mmoles of tert-butyl-n-propyldimethoxysilane and 15 g of the solid catalyst prepared in the above were added, and the catalyst was preactivated by continuously supplying 15 g of propylene over 30 minutes while maintaining the interior temperature of the vessel within a rage of 5 to 15° C., and the slurry of the solid catalyst was transferred to a SUS autoclave having an inner volume of 200 liters equipped with a stirrer. The slurry was diluted by with 140 liters of liquid butane, and was stored at a temperature of 5° C. or less.

Production of Polypropylene Composition

First Step

In a SUS polymerization vessel having an inner volume of 40 liters equipped with a stirrer, liquid propylene was supplied at a rate of 35 kg/hr. and hydrogen was supplied at a rate sufficient for maintaining the concentration of hydrogen in the gas phase at 2.5% by volume. Furthermore, the preactivated solid catalyst, triethylaluminum and tert-butyl-n-propyldimethoxysilane were supplied at a rate of 0.6 g/hr., a rate of 47 mmol/hr. and a rate of 5 mmol/hr., respectively. Under the above conditions, the slurry polymerization using liquid propylene as a solvent was performed at a polymerization temperature of 60° C. while retaining substantially 20 liters of the slurry in the vessel. The production rate of the propylene homopolymer was 1.1 kg/hr., and [η]_{A1} of the polymer was 1.9 dl/g according to the analysis of a part of the polymer. The slurry containing the polymer obtained was continuously transferred to the polymerization vessel for the second step without the deactivation of the catalyst.

Second Step

Propylene, hydrogen and 1-butene were supplied to a gas phase fluidized bed reactor having an inner volume of 1 m³ equipped with a stirrer so as to maintain an amount of the polymer retained in the fluidized bed of 80 kg, a polymerization temperature of 80° C., a polymerization pressure of 1.8 MPa, a hydrogen concentration in the gas phase of 0.5% by volume and a 1-butene concentration in the gas phase of 2.7% by volume. Under these conditions, the solid catalyst-containing polymer transferred from the reaction vessel for the first step was supplied, and the continuous polymerization was carried out to obtain a powdery polypropylene composition at a rate of 21.3 kg/hr. The 1-butene content and [η]_{AB} of the composition were 2.5% by weight and 2.0 dl/g, respectively. The weight ratio of the polymer (A1) prepared in the first step to the polymer (B1) prepared in the second step was 5:95. The 1-butene content and [η]_{B1} of component (B1) were 2.63% by weight and 2.0 dl/g, respectively.

Pelletization of Polypropylene Composition

Pellets were produced by mixing and melt kneading 0.01 part by weight of hydrotalcite, 0.15 part by weight of IRGANOX® 1010 (manufactured by Ciba Specialty Chemicals) and 0.10 parts by weight of IRGAFOS® 168 (manufactured by Ciba Specialty Chemicals) per 100 parts by weight of the powder of the polypropylene composition obtained. The properties of the pellets obtained are shown in Table 2.

Production of Biaxially Stretched Film

The pellets obtained in the previous step were melt kneaded at 260° C. using a T-die extruder having a screw of 65 mmφ, and an extruded sheet was quenched with a cooling roll at 30° C. The sheet was stretched in the longitudinal direction at a draw ratio of 5 by the circumference velocity difference of rolls of a longitudinal stretching machine while heating at 145° C., and then stretched in the transverse direction with a tenter at a draw ratio of 8 at 157° C. in a heating chamber. Thereafter, the sheet was heat-set at 165° C. to obtain a biaxially stretched film with a thickness of 25 μm. The properties of the film obtained are shown in Table 3.

### EXAMPLE 2

The solid catalyst used in this Example was the same as one used in Example 1 and it was preactivated by the same method as in Example 1.

First step

Into a SUS polymerization vessel having an inner volume of 40 liters equipped with a stirred, liquid propylene was supplied at a rate of 35 kg/hr., 1-butene was supplied at a rate of 2.0 kg/hr. and hydrogen was supplied for maintaining the concentration of hydrogen in the gas phase at 3.3% by volume. Furthermore, the preactivated solid catalyst, triethylaluminum and tert-butyl-n-propyldimethoxysilane were supplied at a rate of 0.6 g/hr., a rate of 51 mmol/hr. and a rate of 5 mmol/hr., respectively. Under these conditions, the slurry polymerization using liquid propylene as a solvent was performed at a polymerization temperature of 60° C. while retaining substantially 20 liters of the slurry in the vessel. The production rate of the copolymer was 1.2 kg/hr., and the 1-butene content and [η]A2 of the copolymer were 2.0% by weight and 1.8 dl/g, respectively, according to the analysis of a part of the copolymer. The slurry containing the copolymer obtained was continuously transferred to the polymerization vessel for the second step without the deactivation of the catalyst.

Second Step

Propylene, hydrogen and 1-butene were supplied to a gas phase fluidized bed reactor having an inner volume of 1 m³ equipped with a stirrer so at to maintain an amount of the polymer retained in the fluidized bed of 60 kg, a polymerization temperature of 80° C., a polymerization pressure of 1.8 MPa, a hydrogen concentration in the gas phase of 0.5% by volume and a 1-butene concentration in the gas phase of 2.7% by volume. Under these conditions, the solid catalyst-containing copolymer transferred from the reactor for the first step was supplied, and the continuous polymerization was carried out to obtain a powder polypropylene composition at a rate of 22.3 kg/hr. The 1-butene content and the [η]_{AB} of the polymer composition were 2.5% by weight and 2.0 dl/g, respectively. The weight ratio of the copolymer (A2) prepared in the first step to the copolymer (B2) prepared in the second step was 5:95, and the 1-butene content and [α]B2 of the copolymer (B2) were 2.5% by weight and 2.0 dl/g, respectively.

Pellets and a biaxially stretched film were obtained by the same methods as in Example 1 except that the polypropylene composition obtained above was used. The properties of the pellets obtained and the properties of the biaxially stretched film are shown in Tables 2 and 3, respectively.

### EXAMPLE 3

The solid catalyst used in this Example was the same as one used in Example 1 and it was preactivated by the same method as in Example 1.

First Step

The polymerization in the first step was carried out by the same method as in Example 1 to obtain a propylene homopolymer having an intrinsic viscosity of 2.14 dl/g. The slurry containing the polymer obtained was continuously transferred to the polymerization vessel for the second step without the deactivation of the catalyst.

Second Step

The polymerization in the second step was carried out by the same method as in Example 2 except that the concentration of 1-butene was changed. The 1-butene content and the [η]_{AB} of the polymer composition were 3.2% by weight and 2.14 dl/g, respectively. The weight ratio of the polymer (A1) prepared in the first step to the copolymer (B1) prepared in the second step was 7:93, and the 1-butene content and [η]_{B1} of the polymer (B1) were 3.4% by weight and 2.14 dl/g, respectively.

Pellets and a biaxially stretched film were obtained by the same methods as in Example 1 except that the polypropylene composition obtained above was used. The properties of the pellets obtained and the properties of the biaxially stretched film are shown in Tables 2 and 3, respectively.

### COMPARATIVE EXAMPLE 1

The solid catalyst used in this Comparative Example was the same as one used in Example 1 and it was preactivated by the same method as in Example 1.

Propylene, hydrogen and 1-butene were supplied to a gas phase fluidized bed reactor having an inner volume of 1 m³ equipped with a stirrer, so as to maintain an amount of the polymer retained in the fluidized bed of 80 kg, a polymerization temperature of 80° C., a polymerization pressure of 1.8 MPa, a hydrogen concentration in the gas phase of 1.6% by volume and a 1-butene concentration in the gas phase of 1.1% by volume. Under these conditions, the gas phase polymerization was performed by supplying the preactivated solid catalyst component at a rate of 0.93 g/hr., triethylaluminum at a rate of 48 mmol/hr. and tert-butyl-n-propyldimethoxysilane at a rate of 6 mmol/hr. to obtain a propylene-1-butene copolymer at a rate of 23.3 kg/hr. The 1-butene content and [η] of the copolymer obtained were 2.2% by weight and 1.9 dl/g, respectively.

Pellets and a biaxially stretched film were produced by the same methods as in Example 1 except that the propylene-1-butene copolymer obtained above was used. The properties of the pellets obtained and the properties of the biaxially stretched film are shown in Tables 2 and 3, respectively.

### COMPARATIVE EXAMPLE 2

The solid catalyst used in this Comparative Example was the same as one used in Example 1 and it was preactivated by the same method as in Example 1.

First Step

The polymerization was carried out by the same method as in Example 2 except that the concentration of 1-butene was changed to obtain a copolymer having a 1-butene content of 2.0% by weight and [η]_{A2} of 2.24 dl/g. The slurry containing the copolymer obtained was continuously transferred to the polymerization vessel for the second step without the deactivation of the catalyst.

Second Step

The polymerization was carried out by the same method as in Example 2 except that the concentration of 1-butene was changed. The 1-butene content and the [η]_{AB} of the polymer composition were 5.8% by weight and 2.20 dl/g, respectively. The weight ratio of the copolymer (A2) prepared in the first step to the copolymer (B2) prepared in the second step was 11:89, and the 1-butene content and [η]_{B2} of the copolymer (B2) were 6.3% by weight and 2.20 dl/g, respectively.

Pellets and a biaxially stretched film were produced by the same methods as in Example 1 except that the propylene-1-butene copolymer obtained above was used. The properties of the pellets obtained and the properties of the biaxially stretched film are shown in Tables 2 and 3, respectively.

TABLE 1

| | | | 1-Butene | 1-Butene | Total content |
|---|---|---|---|---|---|
| | | Ratio of | content of | content of | of 1-butene |
| Example | Polymer | A1:B1 or | A1 or A2 | B1 or B2 | in composition |
| No. | type | A2:B2 | (wt. %) | (wt. %) | (wt. %) |
| 1 | A1/B1 | 5:95 | 0 | 2.6 | 2.5 |
| 2 | A2/B2 | 5:95 | 2.0 | 2.5 | 2.5 |
| 3 | A1/B1 | 7:93 | 0 | 3.4 | 3.2 |
| Comp. 1 | * | — | — | — | 2.2 |
| Comp. 2 | A2/B2 | 11:89 | 2.0 | 6.3 | 5.8 |

Note:
* Propylene-1-butene copolymer alone.

TABLE 2

| | | | Melting |
|---|---|---|---|
| Example | MFR | CXS | point |
| No. | (g/10 min.) | (wt. %) | (° C.) |
| 1 | 2.3 | 0.4 | 160 |
| 2 | 2.3 | 0.4 | 160 |
| 3 | 3.7 | 0.2 | 157 |
| Comp. 1 | 2.5 | 0.4 | 160 |
| Comp. 2 | 2.2 | 0.4 | 153 |

TABLE 3

| | Heat shrinkage factor | | Young's modulus |
|---|---|---|---|
| Example | at 130° C. | at 140° C. | (MPa) |

| No. | MD | TD | MD | TD | MD | TD |
|---|---|---|---|---|---|---|
| 1 | 2.4 | 2.0 | 3.4 | 4.6 | 2440 | 4830 |
| 2 | 2.4 | 2.5 | 3.4 | 5.3 | 2480 | 4850 |
| 3 | 2.6 | 1.6 | 3.8 | 3.7 | 2420 | 4160 |
| Comp. 1 | 2.8 | 2.3 | 4.1 | 5.8 | 2250 | 4340 |
| Comp. 2 | 3.0 | 1.5 | 4.0 | 3.7 | 1940 | 3230 |

The above results show that the biaxially stretched films produced in Examples 1, 2 and 3 according to the present invention have better dimensional stability at high temperatures and rigidity than those produced in Comparative Examples 1 and 2.

The polypropylene composition of the present invention is suitably used as a material of a film, in particular, a biaxially stretched film, which has excellent dimensional stability at high temperatures and rigidity. The biaxially stretched films produced from the polypropylene composition of the present invention can be used for lamination films, barrier films, aqueous ink printing films, release sheet films, surface protective films and food package films.

1. A polypropylene composition comprising 0.1 to 15% by weight of component (A1) that is a propylene homopolymer, and 85 to 99.9% by weight of component (B1) that is a copolymer of propylene and at least one α-olefin having at least 4 carbon atoms, provided that the total weight of the component (A1) and the component (B1) is 100% by weight, wherein the component (B1) contains 0.1 to 5% by weight of α-olefin having at least 4 carbon atoms.

2. A polypropylene composition comprising 0.1 to 15% by weight of component (A2) that is a copolymer of propylene and at least one α-olefin having at least 4 carbon atoms and 85 to 99.9% by weight of component (B2) that is a copolymer of propylene and at least one α-olefin having at least 4 carbon atoms, provided that the total weight of the component (A2) and the component (B2) is 100% by weight, wherein the component (A2) contains 0.1 to 5% by weight of α-olefin having at least 4 carbon atoms,
the component (B2) contains 0.2 to 5% by weight of α-olefin having at least 4 carbon atoms, and
the content of the α-olefin having at least 4 carbon atoms in the component (B2) is larger than the content of the α-olefin having at least 4 carbon atoms in the component (A2).

3. A film comprising the polypropylene composition according to claim 1 or 2.

4. The film according to claim 3, wherein the film is a biaxially stretched film.
